(19) United States
(12) Patent Application Publication
(10) Pub. No.: US 2018/0363700 A1
(43) Pub. Date: Dec. 20, 2018

(54) CYLINDRICAL ROLLER BEARING AND METHOD FOR MANUFACTURING A CYLINDRICAL ROLLER BEARING

(71) Applicant: Schaeffler Technologies AG & Co. KG, Herzongenaurach (DE)

(72) Inventors: Reinhard Kick-Rodenbücher, Nürnberg (DE); Markus Mantau, Veitsbronn (DE); Rainer Eidloth, Herzogenaurach (DE)

(73) Assignee: Schaeffler Technologies AG & Co. KG, Herzogenaurach (DE)

(21) Appl. No.: 15/742,926

(22) PCT Filed: Jun. 8, 2016
(86) PCT No.: PCT/DE2016/200268

§ 371 Date: Jan. 9, 2018

(30) Foreign Application Priority Data
Jul. 9, 2015 (DE) 102015212829.6

(51) Int. Cl. F16C 19/22; F16C 35/04; F16C 33/60; F16C 19/26

(52) U.S. Cl. CPC F16C 19/225; F16C 35/045; F16C 33/64; F16C 19/26; F16C 33/605

(57) ABSTRACT

Cylindrical roller bearings and methods for the production thereof are disclosed, wherein the cylindrical roller bearings can be manufactured inexpensively and with adequately high quality.

The cylindrical roller bearing may have an inner ring, an outer ring, and a multiplicity of cylindrical rollers, wherein the cylindrical rollers are arranged between the inner ring and the outer ring. The outer ring has an internal raceway for the cylindrical rollers, a fixed-rim portion, and a flanged-rim portion. The inner ring has an external raceway for the cylindrical rollers, and the internal raceway and/or the external raceway are/is formed into a final contour by extrusion.

### CROSS-REFERENCE TO RELATED APPLICATIONS

This application is the U.S. National Phase of PCT Appln. No. PCT/DE2016/200268 filed Jun. 8, 2016, which claims priority to DE 102015212829.6 filed Jul. 9, 2015, the entire disclosures of which are incorporated by reference herein.

### TECHNICAL FIELD

The disclosure relates to a cylindrical roller bearing having an inner ring, having an outer ring and having a multiplicity of cylindrical rollers, wherein the cylindrical rollers are arranged between the inner ring and the outer ring. The outer ring has an internal raceway for the cylindrical rollers, has a fixed-rim portion and has a flanged-rim portion, and the inner ring has an external raceway for the cylindrical rollers. The disclosure also relates to a method for manufacturing the cylindrical roller bearing.

### BACKGROUND

Cylindrical roller bearings have cylindrical rollers as rolling bodies. The cylindrical roller bearings may be formed as a radial rolling bearing and, in this structural form, transmit radial loads. The raceways of the cylindrical roller bearings are formed as cylindrical shell surfaces coaxially and concentrically with respect to the respective axis of rotation of the cylindrical roller bearing. Normally, bearing rings for cylindrical roller bearings are manufactured as solid rings, that is to say are formed out of a solid semi-finished part by means of cutting, material-removing and in particular chip-removing machining processes. Such cylindrical roller bearings form the closest prior art.

Aside from solid rings, production of rings for bearings by deformation has already become known. For example, document U.S. Pat. No. 2,267,229 discloses the manufacture of rings proceeding from a circular-ring-shaped disk by means of a deformation step.

### SUMMARY

It is an object of the present disclosure to propose a cylindrical roller bearing and a method for the production thereof, such that the cylindrical roller bearing can be manufactured inexpensively and with adequately high quality.

Said object may be achieved by means of the cylindrical roller bearings having the features described herein and by means of the disclosed methods. Additional embodiments of the disclosure are also described in the following description and from the appended figures.

The subject of the disclosure is thus a cylindrical roller bearing which may be formed in particular as a radial rolling bearing, specifically with a pressure angle of 0 degrees. The cylindrical roller bearing has an inner ring and an outer ring, wherein the inner ring and the outer ring are arranged coaxially and/or concentrically with respect to one another and with respect to a main axis of rotation of the cylindrical roller bearing. Furthermore, the cylindrical roller bearing comprises a multiplicity of cylindrical rollers, wherein the cylindrical rollers are arranged so as to roll between the inner ring and the outer ring.

The inner ring and the outer ring have in each case one raceway section, wherein the raceway section has a material thickness of preferably more than two millimeters and in particular of more than three millimeters. The inner ring and/or outer ring may be of thick-walled form. The cylindrical rollers are preferably formed with a diameter/length ratio of greater than 1:10, such as greater than 1:5. The cylindrical rollers have a cylindrical shell surface running in encircling fashion about its own axis of rotation, and two face sides which form terminations of the cylindrical roller.

The outer ring has, in particular in the region of the raceway section, an internal raceway, and the inner ring has, in particular in the region of the raceway section, an external raceway, in each case for the cylindrical rollers. During the operation of the cylindrical roller bearing, the cylindrical rollers roll over the internal raceway and external raceway respectively.

Furthermore, the outer ring has a fixed-rim portion and a flanged-rim portion, wherein the two sections guide the cylindrical rollers or an optional cage of the cylindrical rollers in an axial direction with respect to the main axis of rotation. For this purpose, the fixed-rim portion has a circular-ring-shaped fixed-rim abutment surface, and the flanged-rim portion has a flanged-rim abutment region. The inner ring and the outer ring are manufactured from metal, such as steel.

It is proposed in the context of the disclosure for the external raceway and/or the internal raceway to be formed into a final contour by extrusion. During the extrusion, the temperature in the workpiece, in this case in the inner ring and in the outer ring respectively, is lower than the recrystallization temperature of the base material of the workpiece. In particular, during the extrusion, an inner-ring blank and an outer-ring blank respectively are deformed at ambient or room temperature, preferably at a temperature of <50 degrees C. During the deformation, it is however possible for higher temperatures to arise owing to the deformation work in the workpiece, wherein the higher temperatures however also lie below the recrystallization temperature of the base material. It is advantageous that, as a result of the extrusion, surface stresses are generated in the inner ring and in the outer ring respectively in the region of the respective raceway, which surface stresses lead to an improvement in performance. It is furthermore advantageous that the manufacturing method of extrusion can be performed very inexpensively specifically in the case of high unit quantities. Overall, the inner ring and the outer ring and thus the cylindrical roller bearing can be produced inexpensively, and exhibit good functional characteristics. By means of the method according to the disclosure, the internal raceway and the external raceway are formed by means of the extrusion, and manufacturing of a final contour or final shape (net-shape manufacturing), specifically of the internal raceway and of the external raceway respectively, is thus made possible. Furthermore, additional working steps, for example the cleaning of scaling that can arise in the case of hot working, can be eliminated.

In one embodiment, the external raceway and/or the internal raceway have a convex curvature, in particular an elevation, in a longitudinal section along a main axis of rotation of the cylindrical roller bearing. In particular, the convex curvature is mirror-symmetrical with respect to a radial plane in the axial center of the respective raceway. It is alternatively or additionally possible for the convex curvature in the longitudinal section to be described as a circular segment, wherein the central point of the circular segment lies in the central plane. In particular, a raceway maximum for the internal raceway is situated centrally, and/or a raceway minimum (with regard to the radial spacing to the main axis of rotation) is situated centrally with respect to the external raceway. Alternatively or in addition, the external raceway and/or the internal raceway is of domed form.

A convex curvature of said type has the effect that, in the unloaded cylindrical roller bearing, the cylindrical rollers have only a small contact region with the external raceway and internal raceway respectively. Owing to the small contact surface, the friction is reduced, such that the cylindrical roller bearing can run with low friction. By contrast, when the cylindrical rollers roll on the external raceway and on the internal raceway respectively, the external raceway and internal raceway are deformed owing to the Hertzian stress, such that the cylindrical rollers have a linear or oval-linear contact region with the respective raceway. In this state, a load can be dissipated over a large contact area.

If one compares the convex curvature of the external raceway and/or the internal raceway with a straight cylindrical shell surface, wherein the cylindrical shell surface is placed against the edge-side, in particular local extremes of the external raceway and internal raceway respectively, then the maximum deviation amounts to at least two micrometers, preferably at least five micrometers. This small deviation is sufficient to reduce the friction. By contrast, it is preferable for the maximum deviation to be less than twenty micrometers, preferably less than ten micrometers. The limitation of the deviation has the effect that, under the intended loading of the cylindrical roller bearing, the external raceway and internal raceway can be deformed such that the cylindrical rollers bear against the raceways in linear fashion.

In a one embodiment of the disclosure, the cylindrical rollers, in a longitudinal section along their own axis of rotation, likewise have a convex curvature on the cylindrical roller raceway. Thus, a convex curvature of the cylindrical rollers rolls on a convex curvature of the raceways of the cylindrical roller bearing.

A further possible measure for reducing the friction in the cylindrical roller bearing is for the fixed-rim portion to form a toroidal fixed-rim abutment surface for the cylindrical rollers. The toroidal fixed-rim abutment surface is distinguished by the fact that it is of circular-ring-shaped form, but is realized in convexly curved fashion in the manner of a donut or torus. The shape may also be referred to as a life belt, a tire or a surface of bead-shaped form with a hole. As viewed in a longitudinal section through the outer ring, the abutment surface extends in the same direction as a radial plane, which is oriented perpendicular to the main axis of rotation of the outer ring, over a circular-ring-shaped region. Within said circular-ring-shaped region, the toroidal fixed-rim abutment surface has a convex curvature, in particular elevation.

It is preferable for the toroidal fixed-rim abutment surface to be manufactured by extrusion. It is particularly preferably provided that the cylindrical rollers likewise have a toroidal contact surface or face side for contact against the toroidal fixed-rim abutment surface of the fixed-rim portion. By means of this refinement, the contact surface between cylindrical roller and fixed-rim portion is particularly small, such that the friction in the cylindrical roller bearing is further minimized.

Owing to the toroidal fixed-rim abutment surface, and possibly furthermore owing to the toroidal design of the face sides of the cylindrical rollers, it is achieved that the contact surface between the face side of the cylindrical rollers and the fixed-rim portion is reduced.

It is furthermore preferable for the flanged-rim portion to form an encircling contact line as a flanged-rim abutment region. For this purpose, it is provided that the flanged-rim portion—likewise viewed in the longitudinal section—has a free end section or collar which is oriented so as to be angled relative to a radial plane perpendicular to the main axis of rotation, such that the flanged-rim abutment region is formed by a free end region, in particular corner region, of the free limb.

In one possible refinement of the disclosure, the fixed-rim portion has, on an axial outer side, a securing contour in the form of a securing groove which is formed in encircling fashion around the main axis of rotation. The securing contour is formed into the fixed-rim portion by extrusion. In one possible refinement of the disclosure, the fixed-rim portion has an encircling parting edge which forms a passage opening of the outer ring.

A further subject of the disclosure relates to a method for manufacturing a cylindrical roller bearing according to the disclosure. In the method, the external raceway of the inner ring is manufactured into a final contour by extrusion from an inner blank, and/or the internal raceway of the outer ring is manufactured into a final contour by extrusion from an outer-ring blank, in a main deformation step. In particular, in the main deformation step, the shaping of the internal raceway and/or of the external raceway into a final contour is realized by means of the extrusion.

The method according to the disclosure may optionally be supplemented by one, some or all of the following steps:

In a first possible step, the outer-ring blank is extruded from a round metal blank. In particular, the outer-ring blank is in this case formed as a cup with an encircling wall and with a base.

In the subsequent main deformation step, the extrusion of the outer-ring blank to form an outer-ring intermediate product is performed, wherein the internal raceway is formed in the main deformation step. It is provided that, in the main deformation step, the base or at least a base edge region of the outer-ring blank is maintained.

In a subsequent optional step, the base is separated out, in particular punched out, of the outer-ring intermediate product in order to form the inner ring.

It may optionally be provided that the separated-out base forms a starting product for the inner ring. The inner ring is manufactured from a circular-ring-shaped disk by means of a main deformation step. The circular-ring-shaped disk may be formed by the base or may be manufactured from another semi-finished part.

In the extrusion of both the outer ring and of the inner ring, raceways are manufactured which, as cylindrical shell surfaces, are oriented coaxially and/or concentrically with respect to the main axis of rotation of the cylindrical roller bearing. Here, it has been found that, as a result of the manufacturing processes, the raceways automatically assume the convex curvature described above. Thus, the active surfaces of a tool for forming the raceways can be formed as straight cylindrical shell surfaces and nevertheless generate raceways which have a convex curvature in the described manner. In particular, in this way, raceways are created which, in principle, are formed as undercut contours in relation to an axial demolding direction.

The toroidal fixed-rim abutment surface is, by contrast, formed into the outer ring by deformation by means of a tool which bears a negative contour of the toroidal fixed-rim abutment surface. The securing groove may be jointly formed in during the production of the outer-ring blank by deformation, or alternatively, the securing groove is formed in during the main deformation step.

### BRIEF DESCRIPTION OF THE DRAWINGS

Further features, advantages and effects of the disclosure will emerge from the following description of a preferred exemplary embodiment of the disclosure and from the appended Figures, in which:

FIGS. 1a, 1b, 1c show an outer ring, an inner ring and a rolling body of a cylindrical roller bearing as an exemplary embodiment of the disclosure; and

FIG. 2 shows an illustration of the method according to the disclosure for manufacturing the cylindrical roller bearing with the components as per FIGS. 1a, 1b, 1c.

### DETAILED DESCRIPTION

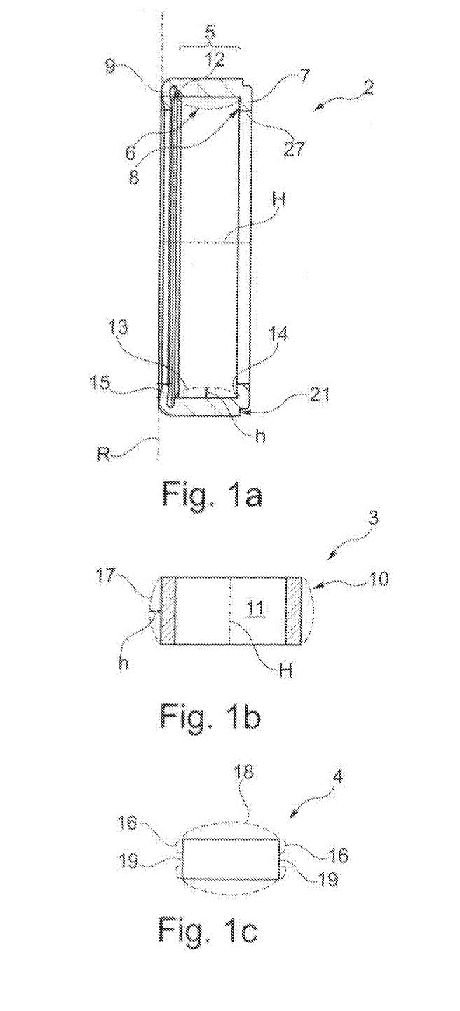

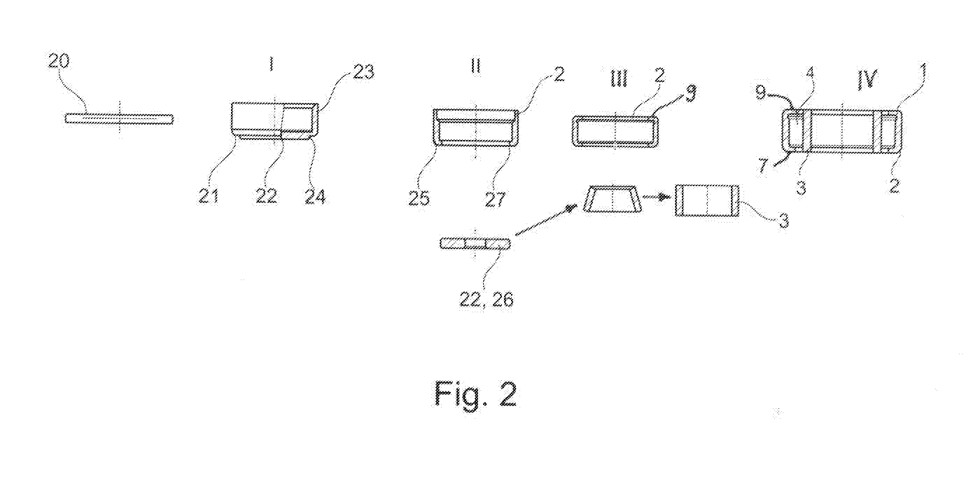

FIG. 1a shows, in a schematic longitudinal section, a first component of a cylindrical roller bearing 1 (see FIG. 2) in the form of an outer ring 2. FIG. 1b shows an inner ring 3 as a further component of the cylindrical roller bearing 1. FIG. 1c illustrates, in highly schematic form, as a further component of the cylindrical roller bearing 1, a rolling body in the form of a cylindrical roller 4. The three components are shown in each case in a schematic longitudinal section along a main axis of rotation H of the cylindrical roller bearing 1.

The outer ring 2 as per FIG. 1a has an internal raceway section 5 which, on the radially inner surface, bears an internal raceway 6. The internal raceway 6 is oriented coaxially and/or concentrically with respect to the main axis of rotation H and, in terms of approximate shape, is realized as a cylindrical shell surface.

At one axial end, a fixed-rim portion 7 is formed integrally on the internal raceway section 5, which fixed-rim portion, in the longitudinal section shown, protrudes at right angles from the internal raceway section 5. The fixed-rim portion 7 provides a fixed-rim abutment surface 8 for the cylindrical rollers 4.

On the opposite axial side, the outer ring 2 has a flanged-rim portion 9, which is likewise angled away from the internal raceway section 5 approximately at right angles. The flanged-rim portion 9 bears a flanged-rim abutment region 12. The outer ring 2 has, for installation purposes, an encircling outer cylindrical-shell-shaped contact surface.

The inner ring 3 is formed as a straight hollow cylinder which is oriented coaxially and/or concentrically with respect to the main axis of rotation H. On its radial outer side, the inner ring 3 bears an external raceway 10. The external raceway 10 is of approximately cylindrical-shell-shaped form. Furthermore, the inner ring 3 has a passage opening 11 for receiving a support structure, such as for example an axle or a shaft.

The cylindrical rollers 4 are arranged between the external raceway 10 and the internal raceway 6, and run or roll on said raceways. In the axial direction, the cylindrical rollers 4 are guided by the fixed-rim portion 7 and the flanged-rim portion 9, or the corresponding fixed-rim abutment surface 8 and the flanged-rim abutment region 12.

Considering the components more closely, the following form-related details are evident:

The internal raceway 6, which is of cylindrical-shell-shaped basic form, has a convex inward curvature in the longitudinal section shown. In FIG. 1a, the convex curvature 13 of the internal raceway 6 is illustrated on an exaggerated scale by means of a dashed line. In relation to a non-curved internal raceway, the convex curvature 13 of the internal raceway 6 has a height h of approximately ten micrometers. The convex curvature 13 of the internal raceway 6 is arranged centrally with respect to the internal raceway 6, such that the extreme of the convex curvature 13 of the internal raceway 6 is situated in the center of the internal raceway 6. The convex curvature 13 may also be referred to as a partially circular curvature.

On the fixed-rim section 7, the fixed-rim abutment surface 8 has a convex curvature 14 of the fixed-rim abutment surface 8, which is of toroidal form in the longitudinal section shown.

In the longitudinal section shown, the flanged-rim section 9 has a free end limb 15 which is oriented approximately perpendicular to the internal raceway section 5. In relation to a radial plane R perpendicular to the main axis of rotation H, the end limb 15 is inclined inwardly toward the internal raceway section 5. In this way, in the longitudinal section, as an abutment surface for the cylindrical rollers 4, there is only a punctiform region or, viewed overall, an encircling linear region as a flanged-rim abutment region 12.

The external raceway 10 of the inner ring 3 likewise has a convex curvature 17 (illustrated on an exaggerated scale by means of a dashed line) which has a height h of approximately ten micrometers in relation to a straight raceway.

As is illustrated very clearly in FIG. 1c, the raceway surface of the cylindrical roller 4 also has a convex curvature 18 of the raceway surface. It is optionally additionally possible for the cylindrical roller 4 to have toroidal encircling structures 16 on each of the face sides 19.

It must be emphasized that the convex curvatures 13, 14, 18 and/or the toroidal structure 16 are illustrated on a greatly exaggerated scale in the Figures, and have a height h of less than 20 micrometers.

By means of the described details, the friction in the cylindrical roller bearing 1 formed from the outer ring 2, the inner ring 3 and a multiplicity of cylindrical rollers 4 (cf. FIG. 2) can be considerably reduced. Specifically, the following improvements are obtained: as a result of the interaction between the internal raceway 6 with the convex curvature 13 and the raceway surface of the cylindrical roller 4, optionally with the convex curvature 18, the friction in the cylindrical roller bearing 1 is reduced. As a result of the interaction between the external raceway 10 with the convex curvature 17 and the raceway surface of the cylindrical roller 4, optionally with the convex curvature 18, the friction in the cylindrical roller bearing 1 is further reduced. The friction in the cylindrical roller bearing 1 is further reduced by the interaction between the convex curvature 14 of the fixed-rim abutment surface 8 and the toroidal structure 16 on the face sides 19 of the cylindrical rollers 4. The friction in the cylindrical roller bearing 1 is further reduced by the interaction between the flanged-rim abutment region 12 and the toroidal structure 16 on the face sides 19 of the cylindrical rollers 4.

FIG. 2 schematically illustrates a method for the manufacture of the cylindrical roller bearing 1 as an exemplary embodiment of the disclosure:

Proceeding from a round metal blank 20, in a preforming phase as per step I, an outer-ring blank 21 is produced. The outer-ring blank 21 has a base 22 and an encircling wall 23. The deformation may be realized for example as a deep-drawing process. It is evident that an encircling securing contour 24 is formed in in the region of the base 22 already in the preforming step. In a subsequent step II, the outer-ring blank 21 is made into an outer-ring intermediate product 25. The step II is also referred to as main deformation step. The base 22 is separated out, in particular punched out, along a parting edge 27. The base 22 or another circular-ring-shaped disk 26 forms a starting product for the inner ring 3. Said inner ring is formed from the circular-ring-shaped disk 26 by turning-down and flaring, as illustrated in the lower row of FIG. 2. In a final step, the outer ring 2 and the inner ring 3 are assembled, and the flanged-rim section 9 is bent.

The convex curvature 13 of the internal raceway 6 and the convex curvature 17 of the external raceway 10 result from an extrusion in the method according to the disclosure. In particular, the active surfaces of the tool for forming the internal raceway 6 and the external raceway 10 are formed as straight cylindrical shell surfaces. The convex curvature 14 of the fixed-rim abutment surface 8 is, by contrast, stamped in by means of a tool with an active surface complementary thereto.

### LIST OF REFERENCE DESIGNATIONS

1 Cylindrical roller bearing
2 Outer ring
3 Inner ring
4 Cylindrical roller
5 Internal raceway section
6 Internal raceway
7 Fixed-rim portion
8 Fixed-rim abutment surface
9 Flanged-rim portion
10 External raceway
11 Passage opening
12 Flanged-rim abutment region
13 Convex curvature of the internal raceway
14 Convex curvature of the fixed-rim abutment surface
15 End limb
16 Toroidal structure
17 Convex curvature of the external raceway
18 Convex curvature of the raceway surface of the cylindrical roller
19 Face side
20 Round metal blank
21 Outer ring blank
22 Base
23 Encircling wall
24 Securing contour
25 Outer ring intermediate product
26 Circular-ring-shaped disk
27 Parting edge
H Main axis of rotation
R Radial plane
H Height (maximum deviation)

1. A cylindrical roller bearing, comprising:
an inner ring, an outer ring, and a multiplicity of cylindrical rollers, wherein the cylindrical rollers are arranged between the inner ring and the outer ring;
wherein the outer ring has an internal raceway for the cylindrical rollers, has a fixed-rim portion and has a flanged-rim portion, and wherein the inner ring has an external raceway for the cylindrical rollers, the internal raceway and/or the external raceway having an extruded final contour.

2. The cylindrical roller bearing as claimed in claim 1, wherein the internal raceway and/or the external raceway has a convex curvature in a longitudinal section along a main axis of rotation (H) of the cylindrical roller bearing.

3. The cylindrical roller bearing as claimed in claim 2, wherein the convex curvature has deviation (h) of at least 2 μm and less than 20 μm in relation to a straight cylindrical shell surface.

4. The cylindrical roller bearing as claimed in claim 1, wherein the cylindrical rollers have a convex curvature in a longitudinal section along a main axis of rotation (H) of the cylindrical roller bearing.

5. The cylindrical roller bearing as claimed in claim 1, wherein the fixed-rim portion forms a toroidal fixed-rim abutment surface and/or a convex curvature of the fixed-rim abutment surface for the cylindrical rollers.

6. The cylindrical roller bearing as claimed in claim 1, wherein the flanged-rim portion forms an encircling contact line as a flanged-rim abutment region.

7. The cylindrical roller bearing as claimed in claim 1, wherein the fixed-rim portion has a securing contour, wherein the securing contour is formed into the fixed-rim portion by deformation by extrusion.

8. The cylindrical roller bearing as claimed in claim 1, wherein the fixed-rim portion has an encircling parting edge.

9. A method for manufacturing a cylindrical roller bearing as claimed in claim 1, wherein the external raceway of the inner ring is manufactured into the extruded final contour by extrusion from an inner-ring blank, and/or the internal raceway of the outer ring is manufactured into the extruded final contour by extrusion from an outer-ring blank.

10. The method as claimed in claim 9, wherein the method has at least one of the following steps:
extrusion of an outer-ring blank from a round metal blank, wherein the outer-ring blank is formed as a cup;
extrusion of the outer-ring blank to form an outer-ring intermediate product, wherein the internal raceway is formed into a final contour; or
cutting a base out of the outer-ring intermediate product in order to form the inner ring.

11. A cylindrical roller bearing, comprising:
an inner ring, an outer ring, and cylindrical rollers, wherein the cylindrical rollers are arranged between the inner ring and the outer ring;
the outer ring having an internal raceway for the cylindrical rollers, a fixed-rim portion, and a flanged-rim portion;
the inner ring having an external raceway for the cylindrical rollers;
the internal raceway and the external raceway having an extruded final contour; and
the internal raceway and the external raceway having a convex curvature in a longitudinal section along a main axis of rotation (H) of the cylindrical roller bearing.

12. The cylindrical roller bearing as claimed in claim 11, wherein the convex curvature has deviation (h) of at least 2 μm and less than 20 μm in relation to a straight cylindrical shell surface.

13. The cylindrical roller bearing as claimed in claim 11, wherein the cylindrical rollers have a convex curvature in a longitudinal section along a main axis of rotation (H) of the cylindrical roller bearing.

14. The cylindrical roller bearing as claimed in claim 11, wherein the fixed-rim portion forms a toroidal fixed-rim abutment surface and/or a convex curvature of the fixed-rim abutment surface for the cylindrical rollers.

15. The cylindrical roller bearing as claimed in claim 11, wherein the flanged-rim portion forms an encircling contact line as a flanged-rim abutment region.

16. The cylindrical roller bearing as claimed in claim 11, wherein the fixed-rim portion has a securing contour, wherein the securing contour is formed into the fixed-rim portion by deformation by extrusion.

17. The cylindrical roller bearing as claimed in claim 11, wherein the fixed-rim portion has an encircling parting edge.

18. A method for manufacturing a cylindrical roller bearing as claimed in claim 11, wherein the external raceway of the inner ring is manufactured into the extruded final contour by extrusion from an inner-ring blank, and/or the internal raceway of the outer ring is manufactured into the extruded final contour by extrusion from an outer-ring blank.

19. The method as claimed in claim 18, wherein the method has at least one of the following steps:
extrusion of an outer-ring blank from a round metal blank, wherein the outer-ring blank is formed as a cup;
extrusion of the outer-ring blank to form an outer-ring intermediate product, wherein the internal raceway is formed into a final contour; or
cutting a base out of the outer-ring intermediate product in order to form the inner ring.
